(19) United States
(12) Patent Application Publication
(10) Pub. No.: US 2012/0139919 A1
(43) Pub. Date: Jun. 7, 2012

(54) 3D ANAGLYPH DISPLAY APPARATUS AND SYSTEM

(75) Inventor: Peter Shintani, San Diego, CA (US)

(73) Assignee: SONY CORPORATION, Tokyo (JP)

(21) Appl. No.: 12/962,642

(22) Filed: Dec. 7, 2010

(51) Int. Cl. G06T 15/50

(52) U.S. Cl. 345/426

(57) ABSTRACT

An apparatus and method for displaying 3D video and imaging on a display system or television set which incorporate a transmissive display coupled over a multi-color backlighting panel having a plurality of distributed color emissive elements (e.g., colored LEDs). In response to detecting the framing output to the transmissive display, the color output of the backlight is alternately sequenced to enhance the anaglyph or to provide definition for alternate right/left image frames. In one implementation, the type of video stream being input (e.g., 2D, 3D, type of 3D, and so forth.) of the video is used in combination with user selected mode settings to determine whether display output is generated in a 2D mode with a fixed color (e.g., white) output or in a 3D mode in which the color alternates between a first and second color of backlighting.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to display systems, and more particularly to 3D video apparatus and methods.

2. Description of Related Art

The creation and display of movies in three dimensions (3D) goes back to at least 1922 when the premiere of “The Power of Love” was shown in theatres. Since that time a fascination has grown regarding the display of 3D moving pictures, which has more recently turned into a consumer market.

Common 3D display technology for projecting stereoscopic image pairs to the viewer include those that require special lenses be worn by the viewer, as well as those “autostereoscopic” systems (Auto 3D) which do not. The principle 3D viewing techniques which require lenses are (1) anaglyphic 3D (colored lenses), (2) polarization 3D (with passive polarized lenses), and (3) alternate-frame sequencing (with active shutter lenses).

Polarized 3D is currently being advanced for theater use in which patrons wear polarity glasses which produce light polarity changes for the left and right eyes. In this system each eye receives a solid image through the polarizing lens.

In order to bring stereoscopic viewing into the home, many different techniques have been considered, including the lensed systems using anaglyphs, polarization and alternate-frame sequencing, but implementation and cost issues have plagued the progress of these systems. For example, to utilize the polarization method, a television would require polarizers to temporally change, or filter, polarization of the radiated light from the images.

To bring stereoscopic viewing into the home, currently available 3D television sets have adopted alternate-sequencing techniques. In these systems, frames are displayed at a high rate, such as approximate 120 frames per second (fps), with alternating frames directed to alternate views for the Left and Right eyes in a L-R-L-R . . . L-R pattern. A pair of “shutter-glasses” are worn which alternatively block the view from one eye while allowing the other eye to see the image. In this way the left eye of the viewer sees frames directed to the left eye, while the right eye of the viewer sees frames directed to the right eye. These sets usually support HDMI 1.4 with a minimum refresh rate of 120 Hz.

However, aside from the cost of requiring expensive pairs of glasses to be worn by each viewer, and the difficulty with using these bulky devices over prescription glasses, there are other issues which have arisen from using shutter glasses, including ghosting, brightness problems, and physiological problems. In that latter category, some reviewers have found that shutter glasses can induce headaches after normal periods of use, such as during a feature length movie. The eye strain, headaches and fatigue, is considered to arise from what has been labeled “convergence-accommodation conflict”, which may be particularly accentuated when alternately blocking the view from each eye.

Accordingly, a need exists for an apparatus and method for home viewing of 3D images on television sets and displays without the problems and costs associated with current systems. These needs and others are met within the present invention, which overcomes the deficiencies of previously developed 3D viewing apparatus and methods.

### BRIEF SUMMARY OF THE INVENTION

The present invention describes a 3D anaglyph system implemented as a specially configured display having a separate light source, such as an LCD display using an actively controlled LED backlight. The apparatus and method utilizes the anaglyph 3D which does not require electronic shutter glasses, and which may be more optic-nerve “friendly” than current systems directed at home use.

Anaglyph images have been used to provide a stereoscopic 3D effect when used in combination with two-color glasses, in which each user eye-piece lens has a different chromatic filter, such as typically red and cyan. The term “anaglyph” comes from the Greek “ana” which means “again”, and “glyph” which means “carving, cutting, or sculpture”. The image corresponding to the perspective as seen from the left eye is displayed in a first color, while the image corresponding to the right eye is attributed to another color. In one of its original forms these images were superimposed onto a composite of the two color layers which are spatially offset to render the depth effect. Typically, the main subject is seen in the center about which the foreground and background are shifted laterally in opposite directions. The picture thus contains two differently filtered colored images, one for each eye. In response to viewing through “color coded” viewing glasses (“anaglyph glasses”), the user sees an integrated stereoscopic image perceived as being three dimensional.

When viewing anaglyphs through appropriately colored glasses each eye sees a slightly different picture. By way of simple illustration, in a red-blue anaglyph the eye covered by the red filter sees the red parts of the image as “white” and the blue parts are seen as “black”, while the eye covered by the blue filter perceives the opposite effect. The portions of the screen which are either truly white or black, however, are perceived the same by each eye. It is the brain which blends the images being received from each eye, which interprets the difference as arising from different subject distances, and which yields a 3D viewing experience. It should be appreciated that modern anaglyph technology has favored moving away from the red-blue example above to red-amber and other combinations which provide the ability to properly render color. The present invention can be configured to operate with any two alternating colors, and/or shades, which can be accompanied by any desired additional lighting colors emitted while either of the two alternating colors are being output.

The use of anaglyph images have seen recent interest for the viewing of still photos, still images and video imaging. The use of low-cost glasses is advantageous, and in the last decade, inexpensive chromatic filter material has been become available for use can which properly render colors, including skin tones.

One of the drawbacks with anaglyph systems is in regard to generating the two color representations for the left and right eyes. The present invention provides a simple implementation of 3D anaglyph imaging suitable for consumer displays and television. In one implementation a high frame rate transmissive display system, such as a Liquid Crystal Display (LCD), is coupled over a backlight (e.g., using Light Emitting Diodes (LEDs)) which is preferably configured to generate white light in response to conventional 2D operations, and to output alternating colored light which is synchronized to video frame output for 3D video viewing. However, the invention can be configured according to the present invention to provide full-time 3D output, such as may be utilized for advertising signage and other select applications. In implementations directed to other applications, any display system which uses a separate light source and display can be adapted according to the teachings herein. For example the light source used within a Liquid Crystal on Silicone (LCoS) display systems (also referred to as SXRD or D-ILA), or with Digital Light Processing (DLP) display systems.

The invention is amenable to being embodied in a number of ways, including but not limited to the following descriptions.

One embodiment of the invention is an apparatus for displaying 3D video and imaging, comprising: (a) a computer processor, and associated memory coupled to the computer processor, configured for controlling a video display or television; (b) a transmissive display configured for displaying image frames of 3D video and imaging at a desired framing rate; (c) a backlight having at least two colors of lighting elements configured to transmit light through said display and of switching colors at a frequency equal to the desired framing rate, wherein the light source comprises at least a first plurality of light emitting elements configured for emitting at a first color and a second plurality of light emitting elements configured for emitting at a second color; (d) programming configured for retention on the memory and executable on the computer processor for, (d)(i) outputting frames of video and/or imaging for display on the transmissive display, (d)(ii) detecting a 3D output mode for the video display or television, (d)(iii) outputting a substantially white light from the backlight when outputting 2D video and images when 3D output mode has not been detected, and (d)(iv) outputting the first color and the second color in an alternating time-sequential pattern, in response to detecting the 3D output mode, so that a first color of backlighting is generated from the first plurality of lighting elements alternated with generating a second color of backlighting from the second plurality of lighting elements in the backlight, wherein the first plurality of lighting elements is activated synchronous with video frame output for a first visual orientation, and the second plurality of lighting elements is activated synchronous with a second visual orientation, whereby in response to viewing the transmissive display with glasses having an appropriate color filter over each eye a perception of three dimensional viewing is obtained.

At least one embodiment of the invention is configured for a transmissive display that can support a framing rate at or above approximately 120 Frames Per Second (fps). In at least one implementation, the apparatus can be configured with a transmissive display comprising a Liquid Crystal Display (LCD). In at least one implementation, the backlight of the apparatus can be configured as an array of Light Emitting Diodes (LEDs). it should be appreciated that at a high framing rate, the backlight color change is not distinguishable to the human eye with integrates these into a composite view.

In at least one embodiment the 3D output mode is determined in response to detecting user input selecting a 3D mode, or detecting 3D in the video encoding protocol, or detecting alternating frame imaging, or in response to a combination thereof. In at least one embodiment 3D output is generated in response to (1) detection of a 3D video input (e.g., alternating right/left views, and/or anaglyph), in combination with (2) a user mode setting which selects 3D output. In at least one embodiment, an alert is provided to the user in response to detecting 3D input, alerting the user to wear their 3D glasses, and/or to select or deselect the 3D output mode.

At least one embodiment of the invention has programming configured for outputting any desired additional lighting color from the backlight during both the first color and the second color. In at least one implementation, the backlight comprises an array of light emitting elements having a plurality of lighting emitting elements in at least three different colors, such as comprising red, green and blue elements, or colors of another complementary color system. In at least one implementation, the light emitting elements comprise at least two different colors of light emitting elements and include white lighting elements. In at least one implementation, the light emitting elements includes a first portion having at least three colors of light emitting elements, and a second portion having at least three colors of lighting elements.

It should be appreciated that the plurality of light emissive elements may comprise a plurality of separate device elements of different colors, or a plurality of device elements, each of which contains multiple color emissive elements (e.g., die) packaged under a single lens.

One embodiment of the invention is an apparatus for displaying 3D video and imaging, comprising: (a) a computer processor, and associated memory coupled to the computer processor, configured for controlling a video display or television; (b) a Liquid Crystal Display (LCD) configured for displaying image frames of 3D video and imaging at a desired framing rate; (c) a backlight retained behind the Liquid Crystal Display (LCD) having at least two colors of lighting elements and capable of switching colors at a frequency equal to the desired framing rate, wherein the backlight comprises at least a first plurality of light emitting elements configured for emitting at a first color and a second plurality of light emitting elements configured for emitting at a second color; (d) programming configured for retention on the memory and executable on the computer processor for, (d)(i) outputting frames of video and/or imaging for display on the Liquid Crystal Display (LCD), (d)(ii) detecting a 3D output mode for the video display or television, (d)(iii) outputting a substantially white light from the backlight when outputting 2D video and images when 3D output mode has not been detected, and (d)(iv) outputting the first color and the second color in an alternating time-sequential pattern, in response to detecting the 3D output mode, so that a first color of backlighting is generated from the first plurality of lighting elements alternated with generating a second color of backlighting from the second plurality of lighting elements in the backlight, wherein the first plurality of lighting elements is activated synchronous with video frame output, such as for a first visual orientation, and the second plurality of lighting elements is activated synchronous with a second visual orientation, whereby in response to viewing the Liquid Crystal Display (LCD) with glasses having an appropriate color filter over each eye a perception of three dimensional viewing is obtained.

One embodiment of the invention is a method of outputting 3D video and imaging on a video display or television, comprising: (a) outputting frames of video, and/or imaging, for display on a transmissive video display or television screen through which light is projected from a plurality of backlighting elements having at least a first and second color in response to the output of at least a first plurality of lighting elements and a second plurality of lighting elements; (b) outputting the first color and the second color in an alternating time-sequential pattern, so that a first color of backlighting is generated from the first plurality of lighting elements alternated with generating a second color of backlighting from the second plurality of lighting elements in the backlight, (c) wherein the first plurality of lighting elements is activated synchronous with video frame output, such as for a first visual orientation, and the second plurality of lighting elements is activated synchronously, such as for a second visual orientation. In response to viewing the transmissive display with glasses having an appropriate color filter over each eye, a perception of three dimensional viewing is obtained.

The present invention provides a number of beneficial elements which can be implemented either separately or in any desired combination without departing from the present teachings.

An element of the invention is a 3D apparatus which is readily implemented in consumer displays and television sets.

Another element of the invention is a 3D display that can be implemented in transmissive display (e.g., Liquid Crystal Display (LCD)) which are backlit by a plurality of light emitting elements (e.g., Light Emitting Diodes (LEDs)).

Another element of the invention is an anaglyph 3D display which alternates the backlighting between a first color and a second color which alternate in sequence with the frames output on the overlying transmissive display.

Another element of the invention is programming executable on a display or television system which detects whether to operate the system in 2D or 3D mode.

Another element of the invention is programming executable on a display or television system which controls synchronized activation/deactivation of different portions of colored backlighting elements in response to the video frame output from the transmissive display being backlit.

Another element of the invention is a system which can detect whether the incoming video stream is formatted for 2D or 3D representation, and automatically controls backlighting color output in response thereto.

Another element of the invention is a multicolor backlighting system which is capable of changing colors at a sufficient framing rate to match the alternate frame output of the transmissive display to which it is coupled (e.g., 120 frames per second (fps)).

Another element of the invention is the ability to utilize the apparatus and method with a variety of mixed-color backlighting elements, such as including any combination selected from R,G, B, and white elements, or colors selected from other color systems, or combinations thereof within separate emissive devices or sharing the same lens within each of the plurality of elements distributed across the backlight panel.

A still further element of the invention is an apparatus and method which can be applied within a variety of display and television systems directed to a wide range of applications.

Further elements of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a 3D video and imaging apparatus according to an aspect of the present invention.

FIG. 2 is a pictorial view of a backlighting panel according to an element of the present invention, showing Red, Green and Blue light emitting elements.

FIG. 3 is a pictorial view of a backlighting panel according to an element of the present invention, showing multicolor light emitting elements which include white light emitters.

FIG. 4 is a pictorial view of a backlighting panel according to an element of the present invention, showing multiple groups of multicolor light emitting elements.

FIG. 5 is a flowchart of 3D anaglyph generation using a backlighting arrangement according to an embodiment of the present invention.

### DETAILED DESCRIPTION OF THE INVENTION

Video signals which are received for 3D output by the display and/or television screen of the invention are typically received over HDMI I/F, although the present invention can receive 3D video information by way of any desired protocols and signal paths. The video input encodes anaglyph information in the frames and/or contains alternating sequential right (R) and left (L) views. Stereoscopic input may be configured in any desired format, including use of frame packing in which left and right views are packed into a single frame, such as comprising SBS (side-by-side) or T&B (top and bottom) encoding. Accordingly, the present invention can utilize anaglyph processed video or receive the same 3D video input signal as utilized by 3D systems which utilize electronic “shutter glasses” controlled by the television to turn on and off separate views to each eye so that the user can see only alternatively right and left images. The present invention, however, overcomes many of the problems associated with “shutter glasses”, such as cost, bulkiness, use with prescription glasses, while it is expected that eye fatigue may also be reduced.

In response to detecting the framing output to the transmissive display, the color output of the backlighting is alternately sequenced to enhance the anaglyph or to provide definition for alternate right/left image frames.

The apparatus and method according to the invention is preferably configured for showing both 2D and 3D video and imaging, and thus is adapted for detecting the presence of 3D signals, and for allowing the user to select the mode as to how these 3D signals should be viewed. For example, the user can elect to view all video source material in 2D, view 3D as it is available, view only certain types of 3D material in 3D, view in 3D only those sources having a given minimum resolution or from a selected video source, be asked on a per case-by-case basis (e.g., video segment basis) to opt for 3D, and other options according to different configurations of the present invention. By way of example, 3D output is preferably output by the display system or television set according to the present invention only in response to detecting the presence of 3D video input, then determining that the user mode setting indicates that the 3D is to be output. An on-screen alert, such as a text string accompanied by an audio annunciation, is preferably generated to the user so that they are reminded to utilize their 3D glasses, and/or to select or deselect the 3D output mode as desired.

In at least one embodiment the frames of the video contain anaglyph images in which the color planes are shifted to provide a stereoscopic view when viewed using the appropriate color filtering. For example, many image processing applications allow shifting one color plane in one direction and another color plane in the opposite direction. The closer the object to the viewer, the greater shift applied during anaglyph processing. In a photo editing suite one can manipulate each color plane, such as moving the red color plane of the foreground to the right a desired number of pixels. It is recognized that more accurate and sophisticated mechanisms exist for generating anaglyph images by which the amount of color shift is determined in response to depth. It should be appreciated that video incorporating any of these types of anaglyphs can be displayed in 3D with the present invention.

Also, in at least one embodiment, the present invention can be utilized by combining alternating right/left images, such as utilized with shutter glasses, which are displayed synchronously with the backlight color change. A form of color glasses then are worn by the user to obtain a 3D color viewing.

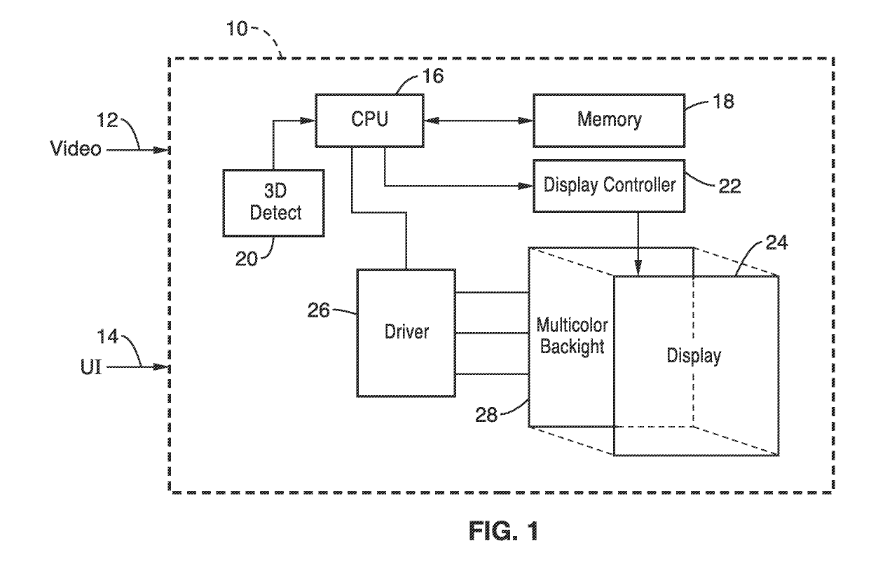

FIG. 1 illustrates an example embodiment 10 of a display system or television set according to the present invention, showing a video input 12 over which 3D video signals can be received. User control inputs 14 are shown, such as for selecting operating features and selecting viewing mode of the system. The system, or at least the backlight control thereof, is exemplified as being controlled by programming which executes on a combination of CPU, or controller, 16 and associated memory 18 from which programming is executed for performing the inventive elements described herein. It should be appreciated that the control aspects of the present invention can be implemented by any desired combination of programmatic elements and/or electronic hardware without departing from the teachings of the present invention. A mode detection block 20 (e.g., programming) is depicted for determining the mode of the video being input, such as whether it is 2D or 3D. A display controller 22 operating is combination with CPU 16, is configured for controlling the display panel 24. A backlight driver 26 is shown coupled to a backlight 28 having a plurality of multiple color emitting elements. It will be appreciated that elements of the present invention are implemented for execution within apparatus 10, such as in response to programming resident in memory 18 which is executable on CPU 16. In addition, it will be appreciated that elements of the present invention can be implemented as programming stored on a media, wherein the media can be accessed for execution by CPU 16.

It can be seen from FIG. 1 that a display system or television set 10 screen according to the present invention, is configured with a backlight 28 which is configured for generating two different light source colors whose output is synchronized to the framing output of the transmissive display, preferably an LCD. The backlight for example may comprise a plurality of multicolor LEDs distributed across the backlight panel to provide even lighting at the selected anaglyph alternating colors in synchronous response to the framing of the images output on the transmissive display being back lit. By way of example, by sequentially controlling the Red and Blue backlighting elements on a backlighting panel comprising Red, Blue, Green light emitters, whereby 3D perception is obtained when wearing passive color filter glasses.

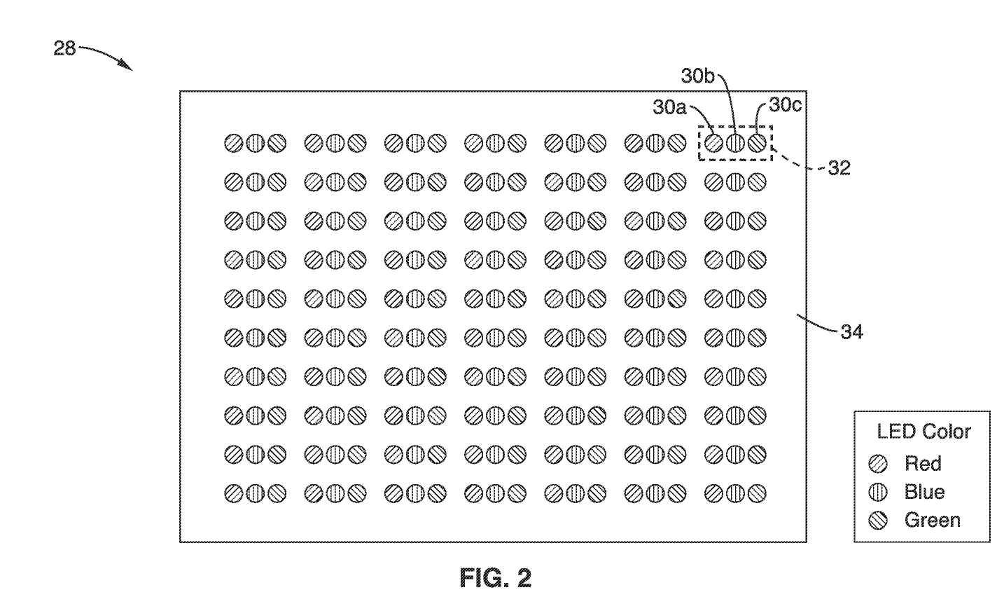

FIG. 2 illustrates an example backlight panel 28 having a plurality of colored light emitting elements 30a-30c, within groups 32 distributed across the face of the base 34 of the panel. In this example, each group 28 contains multiple colored light emissive elements, represented by red 30a, green 30b and blue 30c light emissive elements. When operated in a 2D mode, each of the multicolor elements can be activated to provide a constant white backlight for the transmissive display panel 24 shown in FIG. 1.

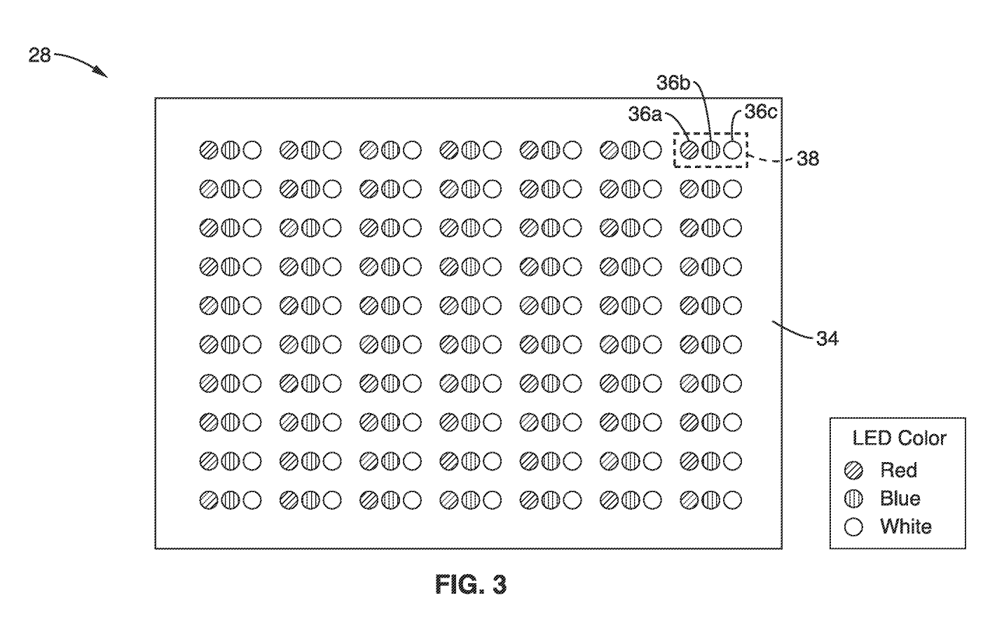

FIG. 3 illustrates another example backlight panel 28 having a plurality of colored light emitting elements 36a-36c, within groups 38 distributed across the face of the base 34 of the panel. In this example, each group 38 containing multiple colored light emissive elements includes a white emissive element. When operating in a 2D mode, the white LED can be used to provide the desired backlighting. A red 36b and green 36c emissive element are shown by way of example, although it should be appreciated that different combinations of light emitting elements may be utilized.

Although not an anaglyph, the present system can be utilized in response to different primary color emissive elements, in which a color filter system is used with closely spaced separate color primary filters for each eye within a preferably passive set of filter glasses.

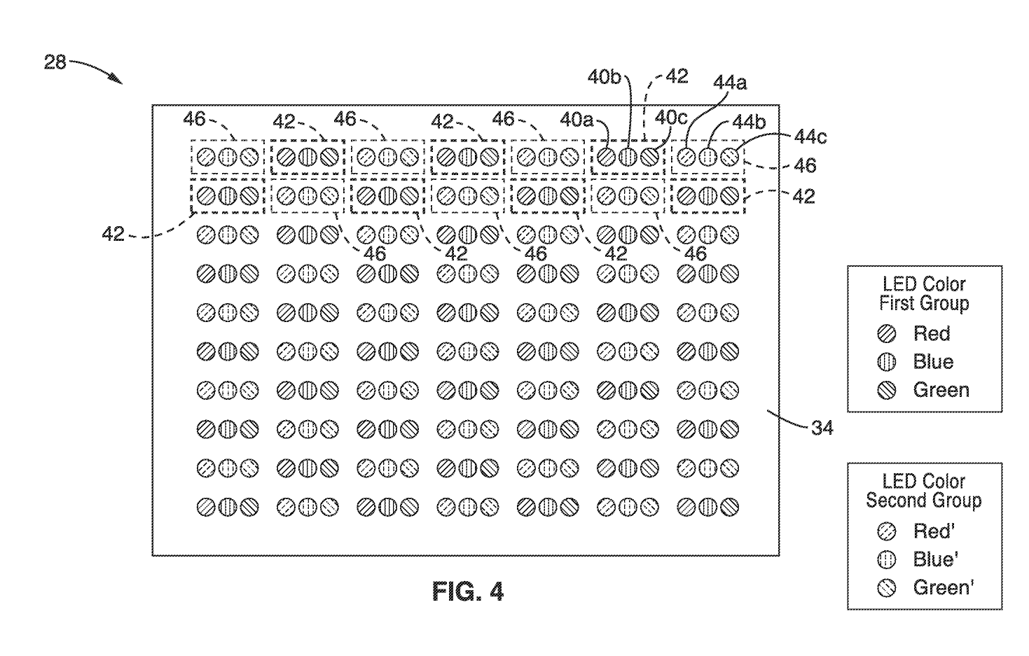

FIG. 4 illustrates another example backlight panel 28 having two different groups of multiple colored light emitting elements 40a-40c, within group 42, and elements 44a-44c within group 46. In this example, group 42 is depicted as red 40a, green 40b, and blue 40c, and group 46 is depicted as having a shifted output with red 44a, green 44b, and blue 44c light emitting elements. When operating in a 2D mode, a desired color-balanced portion of these elements can be activated to generate a while backlight. When operating in 3D mode one group (e.g., group 42) of RGB emitting elements (e.g., LEDs) have different wavelengths (or are operated at different wavelengths) than the other group (e.g., group 46) of emitting elements (e.g., LEDs) which allows generating two different color backgrounds synchronized Left and Right framing of the video being output. Similarly, two arrays of white emitters could be used, with each array having a different spectral output, which for example can be utilized in conjunction with additional filters to produce the same effect of two sets of primaries.

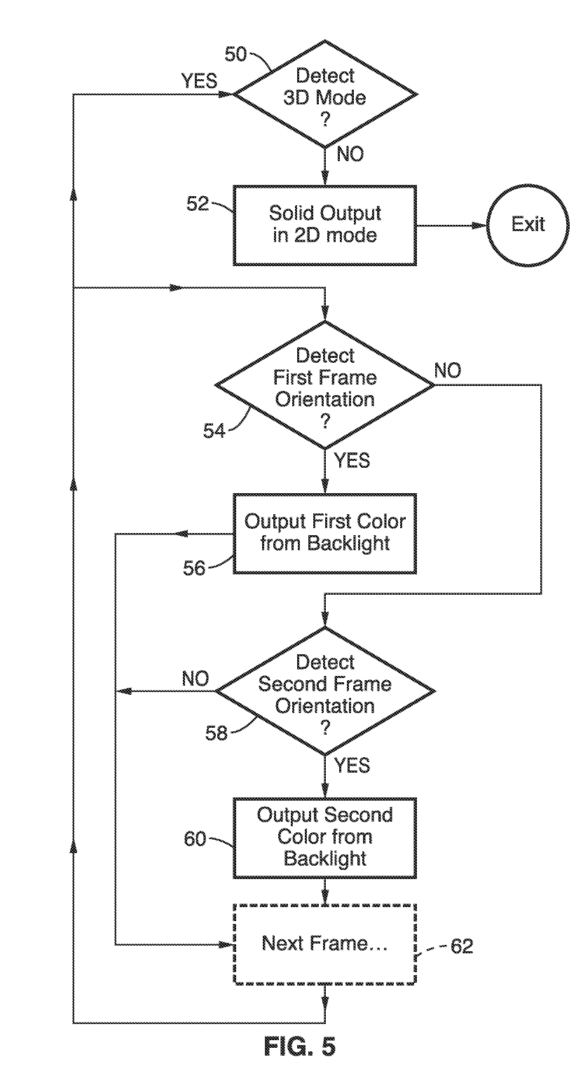

FIG. 5 illustrates an embodiment of the present 3D display apparatus and method exemplified as programming being executed on a display system or television set. It will be appreciated that the flowchart is simplified for the sake of simplicity of illustration. In response to receiving a video signal a check is made 50 for 3D within the received video. If the video is not in a 3D mode, then a solid output color, preferably white, is generated 52 such as by activating white light emitting elements or activating multiple color elements whose combination renders a white light output. No additional backlight processing is required during playing of conventional 2D video. In response to detection of 3D video, and assuming that 3D output is selected, the frame orientation is detected as per block 54, if true, then a first color is output 56 from the backlight synchronized with the frame change. Otherwise, a check for a second frame orientation is performed 58, and if true, a second color is output 60 from the backlight. Then the next frame is checked 62 and so forth so that the backlight is alternated in color in a sequential alternating pattern to match the 3D imaging being output on the transmissive display panel to which the backlight is coupled.

It will be appreciated that the teachings of the present invention can be adapted for implementation on display systems which are not strictly transmissive and which may not require the use of a plurality of light emitting elements. The following provided by way of example and not limitation.

A liquid crystal on silicon (LCoS) display utilizes a silicon chip as a substrate and typically a standard CMOS process to form pixel cell matrices, integrated drivers, and other electronic devices on the silicon chip. The principle structures of an LCoS display includes a light source module, an LCoS panel, and a color separation and combination optical system. A pixel of the LCoS display includes a single micro-mirror, along with its associated layers. An LCoS display may use a single mirror, multiple mirrors or even a single mirror for each pixel. Polarized lenses are used in the LCoS to modulate light transmission to individual pixels within the pixel array. LCoS displays are thus sometimes referred to as light modulators.

DLP stands for digital light processing and is a another display technology which creates an image utilizing a serous of mirrors, with each mirror generally corresponding to a single pixel in an image.

These display systems and others can be adapted to detect a 3D output mode, to modulate display lighting colors in response to first and second view directions (e.g., left and right) which is synchronized with the video frame output from the display device.

From the description herein, it will be further appreciated that the invention can be embodied in various ways, which include but are not limited to the following.

The present invention provides methods and apparatus for rendering 3D video and imaging on a display screen or television set using a transmissive display and a backlight configured for outputting synchronized alternating backlight colors.

As can be seen, therefore, the present invention includes the following inventive embodiments among others:

1. An apparatus for displaying 3D video and imaging, comprising: a computer processor, and associated memory coupled to said computer processor, configured for controlling a video display or television; a transmissive display configured for displaying image frames of 3D video and imaging at a desired framing rate; a backlight retained behind said transmissive display having at least two colors of lighting elements and capable of switching colors at a frequency equal to the desired framing rate; wherein said backlight comprises at least a first plurality of light emitting elements configured for emitting at a first color and a second plurality of light emitting elements configured for emitting at a second color; programming configured for retention on said memory and executable on said computer processor for, outputting frames of video and/or imaging for display on said transmissive display, detecting a 3D output mode for said video display or television, outputting a substantially white light from said backlight when outputting 2D video and images when 3D output mode has not been detected, and outputting the first color and the second color in an alternating time-sequential pattern, in response to detecting the 3D output mode, so that a first color of backlighting is generated from said first plurality of lighting elements alternated with generating a second color of backlighting from said second plurality of lighting elements in said backlight, wherein said first plurality of lighting elements is activated synchronous with video frame output for a first visual orientation, and said second plurality of lighting elements is activated synchronous with a second visual orientation, whereby in response to viewing said transmissive display with glasses having an appropriate color filter over each eye a perception of three dimensional viewing is obtained.

2. The apparatus as recited in embodiment 1, wherein said transmissive display can support a framing rate at or above 120 Frames Per Second (fps).

3. The apparatus as recited in embodiment 1, wherein said 3D output mode is detected in response to detecting user input selecting a 3D mode, determined in response to detecting 3D in the video encoding protocol, determined in response to detecting alternating frame imaging, and/or a combination thereof.

4. The apparatus as recited in embodiment 1, further comprising programming for outputting any desired additional lighting color from said backlight during both said first color and said second color.

5. The apparatus as recited in embodiment 1, wherein said transmissive display comprises a Liquid Crystal Display (LCD).

6. The apparatus as recited in embodiment 1, wherein said backlight comprises an array of Light Emitting Diodes (LEDs).

7. The apparatus as recited in embodiment 1, wherein said backlight comprises an array of light emitting elements having a plurality of lighting emitting elements in at least three different colors.

8. The apparatus as recited in embodiment 7, wherein said array of light emitting elements comprises red, green and blue elements.

9. The apparatus as recited in embodiment 7, wherein said array of light emitting elements comprises at least two different colors of light emitting elements and white lighting elements.

10. The apparatus as recited in embodiment 7, wherein said array of light emitting elements comprises includes a first portion having at least three colors of light emitting elements, and a second portion having at least three colors of lighting elements.

11. An apparatus for displaying 3D video and imaging, comprising: a computer processor, and associated memory coupled to said computer processor, configured for controlling a video display or television; a Liquid Crystal Display (LCD) configured for displaying image frames of 3D video and imaging at a desired framing rate; a backlight retained behind said Liquid Crystal Display (LCD) having at least two colors of lighting elements and capable of switching colors at a frequency equal to the desired framing rate; wherein said backlight comprises at least a first plurality of light emitting elements configured for emitting at a first color and a second plurality of light emitting elements configured for emitting at a second color; programming configured for retention on said memory and executable on said computer processor for, outputting frames of video and/or imaging for display on said Liquid Crystal Display (LCD), detecting a 3D output mode for said video display or television, outputting a substantially white light from said backlight when outputting 2D video and images when 3D output mode has not been detected, and outputting the first color and the second color in an alternating time-sequential pattern, in response to detecting the 3D output mode, so that a first color of backlighting is generated from said first plurality of lighting elements alternated with generating a second color of backlighting from said second plurality of lighting elements in said backlight, wherein said first plurality of lighting elements is activated synchronous with video frame output for a first visual orientation, and said second plurality of lighting elements is activated synchronous with a second visual orientation, whereby in response to viewing said Liquid Crystal Display (LCD) with glasses having an appropriate color filter over each eye a perception of three dimensional viewing is obtained.

12. The apparatus as recited in embodiment 11, wherein said Liquid Crystal Display (LCD)can support a framing rate at or above 120 Frames Per Second (fps).

13. The apparatus as recited in embodiment 11, wherein said 3D output mode is detected in response to detecting user input selecting a 3D mode, determined in response to detecting 3D in the video encoding protocol, determined in response to detecting alternating frame imaging, and/or a combination thereof.

14. The apparatus as recited in embodiment 11, further comprising programming for outputting any desired additional lighting color from said backlight during both said first color and said second color.

15. The apparatus as recited in embodiment 11, wherein said backlight comprises an array of Light Emitting Diodes (LEDs).

16. The apparatus as recited in embodiment 11, wherein said backlight comprises an array of light emitting elements having a plurality of lighting emitting elements in at least three different colors.

17. The apparatus as recited in embodiment 16, wherein said array of light emitting elements comprises red, green and blue elements.

18. The apparatus as recited in embodiment 16, wherein said array of light emitting elements comprises at least two different colors of light emitting elements and white lighting elements.

19. The apparatus as recited in embodiment 16, wherein said array of light emitting elements comprises a first portion having at least three colors of light emitting elements, and a second portion having at least three colors of lighting elements.

20. A method of outputting 3D video and imaging on a video display or television, comprising: outputting frames of video, and/or imaging, for display on a transmissive video display or television screen through which light is projected from a plurality of backlighting elements having at least a first and second color in response to the output of at least a first plurality of lighting elements and a second plurality of lighting elements; outputting the first color and the second color in an alternating time-sequential pattern, so that a first color of backlighting is generated from said first plurality of lighting elements alternated with generating a second color of backlighting from said second plurality of lighting elements in said backlight, wherein said first plurality of lighting elements is activated synchronous with video frame output for a first visual orientation, and said second plurality of lighting elements is activated synchronous with a second visual orientation, whereby in response to viewing said transmissive display with glasses having an appropriate color filter over each eye a perception of three dimensional viewing is obtained.

Embodiments of the present invention are described with reference to flowchart illustrations of methods and systems according to embodiments of the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for displaying 3D video and imaging, comprising:
a computer processor, and associated memory coupled to said computer processor, configured for controlling a video display or television;
a transmissive display configured for displaying image frames of 3D video and imaging at a desired framing rate;
a backlight retained behind said transmissive display having at least two colors of lighting elements and capable of switching colors at a frequency equal to the desired framing rate;
wherein said backlight comprises at least a first plurality of light emitting elements configured for emitting at a first color and a second plurality of light emitting elements configured for emitting at a second color;
programming configured for retention on said memory and executable on said computer processor for,
outputting frames of video and/or imaging for display on said transmissive display,
detecting a 3D output mode for said video display or television,
outputting a substantially white light from said backlight when outputting 2D video and images when 3D output mode has not been detected, and
outputting the first color and the second color in an alternating time-sequential pattern, in response to detecting the 3D output mode, so that a first color of backlighting is generated from said first plurality of lighting elements alternated with generating a second color of backlighting from said second plurality of lighting elements in said backlight,
wherein said first plurality of lighting elements is activated synchronous with video frame output for a first visual orientation, and said second plurality of lighting elements is activated synchronous with a second visual orientation, whereby in response to viewing said transmissive display with glasses having an appropriate color filter over each eye a perception of three dimensional viewing is obtained.

2. The apparatus as recited in claim 1, wherein said transmissive display can support a framing rate at or above 120 Frames Per Second (fps).

3. The apparatus as recited in claim 1, wherein said 3D output mode is detected in response to detecting user input selecting a 3D mode, determined in response to detecting 3D in the video encoding protocol, determined in response to detecting alternating frame imaging, and/or a combination thereof.

4. The apparatus as recited in claim 1, further comprising programming for outputting any desired additional lighting color from said backlight during both said first color and said second color.

5. The apparatus as recited in claim 1, wherein said transmissive display comprises a Liquid Crystal Display (LCD).

6. The apparatus as recited in claim 1, wherein said backlight comprises an array of Light Emitting Diodes (LEDs).

7. The apparatus as recited in claim 1, wherein said backlight comprises an array of light emitting elements having a plurality of lighting emitting elements in at least three different colors.

8. The apparatus as recited in claim 7, wherein said array of light emitting elements comprises red, green and blue elements.

9. The apparatus as recited in claim 7, wherein said array of light emitting elements comprises at least two different colors of light emitting elements and white lighting elements.

10. The apparatus as recited in claim 7, wherein said array of light emitting elements comprises includes a first portion having at least three colors of light emitting elements, and a second portion having at least three colors of lighting elements.

11. An apparatus for displaying 3D video and imaging, comprising:
a computer processor, and associated memory coupled to said computer processor, configured for controlling a video display or television;
a Liquid Crystal Display (LCD) configured for displaying image frames of 3D video and imaging at a desired framing rate;
a backlight retained behind said Liquid Crystal Display (LCD) having at least two colors of lighting elements and capable of switching colors at a frequency equal to the desired framing rate;
wherein said backlight comprises at least a first plurality of light emitting elements configured for emitting at a first color and a second plurality of light emitting elements configured for emitting at a second color;
programming configured for retention on said memory and executable on said computer processor for,
outputting frames of video and/or imaging for display on said Liquid Crystal Display (LCD),
detecting a 3D output mode for said video display or television,
outputting a substantially white light from said backlight when outputting 2D video and images when 3D output mode has not been detected, and
outputting the first color and the second color in an alternating time-sequential pattern, in response to detecting the 3D output mode, so that a first color of backlighting is generated from said first plurality of lighting elements alternated with generating a second color of backlighting from said second plurality of lighting elements in said backlight,
wherein said first plurality of lighting elements is activated synchronous with video frame output for a first visual orientation, and said second plurality of lighting elements is activated synchronous with a second visual orientation, whereby in response to viewing said Liquid Crystal Display (LCD) with glasses having an appropriate color filter over each eye a perception of three dimensional viewing is obtained.

12. The apparatus as recited in claim 11, wherein said Liquid Crystal Display (LCD)can support a framing rate at or above 120 Frames Per Second (fps).

13. The apparatus as recited in claim 11, wherein said 3D output mode is detected in response to detecting user input selecting a 3D mode, determined in response to detecting 3D in the video encoding protocol, determined in response to detecting alternating frame imaging, and/or a combination thereof.

14. The apparatus as recited in claim 11, further comprising programming for outputting any desired additional lighting color from said backlight during both said first color and said second color.

15. The apparatus as recited in claim 11, wherein said backlight comprises an array of Light Emitting Diodes (LEDs).

16. The apparatus as recited in claim 11, wherein said backlight comprises an array of light emitting elements having a plurality of lighting emitting elements in at least three different colors.

17. The apparatus as recited in claim 16, wherein said array of light emitting elements comprises red, green and blue elements.

18. The apparatus as recited in claim 16, wherein said array of light emitting elements comprises at least two different colors of light emitting elements and white lighting elements.

19. The apparatus as recited in claim 16, wherein said array of light emitting elements comprises a first portion having at least three colors of light emitting elements, and a second portion having at least three colors of lighting elements.

20. A method of outputting 3D video and imaging on a video display or television, comprising:
outputting frames of video, and/or imaging, for display on a transmissive video display or television screen through which light is projected from a plurality of backlighting elements having at least a first and second color in response to the output of at least a first plurality of lighting elements and a second plurality of lighting elements;
outputting the first color and the second color in an alternating time-sequential pattern, so that a first color of backlighting is generated from said first plurality of lighting elements alternated with generating a second color of backlighting from said second plurality of lighting elements in said backlight,
wherein said first plurality of lighting elements is activated synchronous with video frame output for a first visual orientation, and said second plurality of lighting elements is activated synchronous with a second visual orientation, whereby in response to viewing said transmissive display with glasses having an appropriate color filter over each eye a perception of three dimensional viewing is obtained.
